(19) United States
(12) Patent Application Publication
(10) Pub. No.: US 2020/0014752 A1
(43) Pub. Date: Jan. 9, 2020

(54) SYSTEM AND DEVICE FOR PERSONAL MESSAGING

(71) Applicants: Teun Friedrich Jozephus Slegers, Helmond (NL); Sebastiaan Serge van der Duim, Eindhoven (NL)

(72) Inventors: Teun Friedrich Jozephus Slegers, Helmond (NL); Sebastiaan Serge van der Duim, Eindhoven (NL)

(21) Appl. No.: 16/484,698

(22) PCT Filed: Feb. 13, 2018
(86) PCT No.: PCT/NL2018/050101

§ 371 Date: Aug. 8, 2019

(30) Foreign Application Priority Data
Feb. 13, 2017 (NL) 2018361
Apr. 19, 2017 (NL) 2018746

(51) Int. Cl. H04L 29/08; H04W 4/12; H04L 12/58; H04M 1/725; G06Q 20/12

(52) U.S. Cl. CPC H04L 67/1097; H04W 4/12; G06Q 20/1235; H04M 1/72555; H04L 51/32

(57) ABSTRACT

A system for messaging over a telecommunication connection makes use of a personal telecommunication device with input means which enable a user to compose a picture message and send it over the telecommunication connection. The picture message includes a primary picture to which further picture elements are added. Selection means enable a user to select one or more further picture elements from a collection of picture elements and combine them with the picture in the picture message to form a composite picture.

### CROSS-REFERENCE TO RELATED APPLICATIONS

This application is the National Stage of International Application No. PCT/NL2018/050101, filed Feb. 13, 2018, which claims the benefit of Netherlands Application No. 2018361, filed Feb. 13, 2017, and Netherlands Application No. 2018746, filed Apr. 19, 2017, the contents of all of which are incorporated by reference herein.

### FIELD OF THE INVENTION

The present invention relates to a system for messaging over a telecommunication connection, comprising a personal telecommunication device with telecommunication means which are intended and configured to at least temporarily maintain a telecommunication connection, and with processor means which are able to execute a program code which enables a user to configure and send an electronic picture message over the telecommunication connection, which picture message comprises at least one first picture element.

### BACKGROUND OF THE INVENTION

Electronic messaging is a phenomenon which is here to stay in today's world with e-mail and social media. Millions of people worldwide bombard each other every moment of the day with messages of diverse nature. The American social network has 1.23 billion active users monthly, 757 million of whom are active daily. Of these 1.23 billion, 945 million make mobile use of Facebook. They spend an average of 8.3 hours monthly on the platform. On an average day Facebook users together share more than 6 billion likes and send no fewer than 10 billion Facebook messages. In the Netherlands there are 9 million registered Facebook accounts.

Mobile use of the micro-blog service Twitter is also very high. 184 million people make mobile use of Twitter monthly. This amounts to three-quarters (76%) of Twitter users. 60% of the 500 million tweets sent daily come from mobile devices. To date a total of 300 billion tweets have already been sent. There are in addition more specific message services such as SMS and the now immensely popular WhatsApp. There are 470 million people who make use of WhatsApp monthly, 9.5 million of these being users in the Netherlands. These users are continuously exchanging messages with each other.

Mentioned above by way of illustration are only a number of messaging services, although various other messaging services can be added to the list, wherein services becoming increasingly more popular such as SnapChat and Instagram deserve particular mention. There would seem to be no end in sight, wherein existing services become larger or smaller and are constantly being superseded by new social media platforms.

Characteristic of all social media channels and messaging services is that users send messages to each other continuously and appear to want to do this to an ever increasing extent and with an ever increasing frequency. Many users therefore seek to keep the time duration for composing a message as short as possible while keeping the information density as high as possible. This is achieved through the use of formal or informal abbreviations in a message and the use of picture elements. This latter category in particular is found to be particularly useful in nevertheless generating a meaningful communication with a short message. The picture elements applied for this purpose are brought together in a collection of so-called emoticons made available to a user by the operating system of a computer or smart phone. By selecting an appropriate emoticon an entire message or emotion can sometimes be exchanged using a single picture element.

With the ever increasing number of messages sent daily per user there is a growing need for more and more communication by means of such picture elements. This form of communication has thus far usually been limited to a standard collection of emoticons provided by the operating system. The present invention has for its object however, among others, to make this form of communication more widely available.

### SUMMARY OF THE INVENTION

In order to achieve the stated object a system of the type described in the preamble has the feature according to the invention that the program code provides access to a public storage location for picture elements located outside the telecommunication device, that the program code provides selection means configured to select one or more further picture elements from the public storage location for picture elements and add them to a personalized preferred collection of picture elements optionally held by the telecommunication device and accessible by the telecommunication device, and that the program code enables the user to select a further picture element(s) from the preferred collection and combine it in the picture message with the at least one first picture element to form a composite image in the picture message. The telecommunication device thus enables the user to combine picture elements to a composite picture and to send this as such.

The primary picture is here for instance a photographic image which has optionally been generated by the user him/herself and optionally with the same device as the telecommunication device. In the system according to the invention one or more further picture elements from the storage location can then be combined therewith to form a composite image. The storage location makes available for this purpose a collection of picture elements which is in principle well nigh unlimited. In addition to the standard emoticons, commercial brand logos of diverse nature and free-form design pictures can also be made available therein. It is possible to respond to occasions and events by designing appropriate picture elements and including or having them included in the collection. These picture elements are then available, optionally for a payment, to all users for inclusion in a picture message to be sent by them.

In a particular embodiment the system according to the invention is characterized in that the telecommunication connection comprises an optionally permanent connection in a telecommunication network, in particular in a public telecommunication network. The telecommunication network is for instance a public wired and/or wireless (mobile) public telephone network over which electronic messaging is possible, and particularly comprises the Internet. A preferred embodiment of the system according to the invention has the feature here that the preferred collection is stored in or on the device, while the storage location is located outside the telecommunication device and is accessible via the telecommunication network. The storage location is provided here by for instance one or more servers connected to the telecommunication network and is thus accessible by all users connected or connectable to the network. Because the preferred collection of picture elements, once it has been assembled and/or configured, is however stored in or on the device, i.e. is accessible directly and also without telecommunication connection, a message can already be composed and configured by a user without network environment and only sent later. Furthermore, the picture elements in the preferred collection can thus be accessed more rapidly.

In order to enable both new and existing telecommunication devices to make full use of the storage location the program code, once it has been loaded into the telecommunication device, grants the user access to the public storage location with picture elements. Said program code can for instance be obtained (downloaded) as so-called App for various operating systems from an App store open to the public for this purpose on the Internet. Once the App has been loaded into the telecommunication device and installed, picture elements can be selected therewith from the collection and added to the picture in the picture message. New picture elements can thus be added if desired from the program code (App) as well as via the Internet.

The system according to the invention provides a platform with which picture messages can be supplemented in a rapid and simple manner with pictures from a library of picture elements held by the storage location. The content of this library can be configured by an administrator of the system. A preferred embodiment of the system has the feature according to the invention however that program code is able and configured to enable the user to add one or more picture elements to the storage location. The system thus enables the user to upload pictures as picture elements to the storage location for later use by him/herself or by others. This public collection then provides access to third parties so that they can download the respective images, optionally for payment, for use in picture messages to be sent by themselves.

The system according to the invention can be configured per se such that the program code fully handles not only the device but also sending of the picture message. A preferred embodiment of the system according to invention has the feature however that the program code is able and configured to send the picture message via a social media application of the telecommunication device, in particular a social media application from a group of social media applications available in the device. Use is thus made of existing functionality already available in the telecommunication device with which picture messages can be exchanged between users in the respective social media environment. The system according to the invention can hereby be platform-independent in the sense that such a path can be provided via various popular social media channels from the same application which also provides for the program code.

The storage location for the collection of selectable picture elements can comprise a physical as well as virtual distributed memory space. A preferred embodiment of the system according to the invention has the feature here that administering means are provided which register a use of a picture element from the storage location. The administering means comprise for instance a counter for keeping track of an incidence of selection and/or use per picture element. In order to provide a user with quicker and simpler access to the most used or popular picture elements, a further preferred embodiment of the system according to the invention has the feature that the administering means are able and configured to determine an incidence of use of a picture element from the storage location and to configure and present the preferred collection on the basis thereof. The picture elements from the storage location incorporated most often in a picture message by the user him/herself or by all users of the system are thus located at the top or on a separate sub-collection in the preferred collection provided by the device. This preferred collection can further be grouped and subdivided into different, for instance subject-related, categories and/or subcategories.

In order to always keep this preferred collection as up to date as possible for the user, a further particular embodiment of the system according to the invention has the feature that the preferred collection comprises a collection of picture elements with a highest incidence of use within exchanged picture messages of the user and/or other users of the system. The picture elements with the highest incidence, i.e. the picture elements most used in messages by the user or other users, thus appear as such in the preferred collection and are preferably arranged therein in order of decreasing incidence.

In order to draw greater attention of users to a provider of a picture element of the collection of picture elements, a further particular embodiment of the system according to the invention has the feature that the administering means are able and configured to assign a priority to a picture element in the storage location and to configure and present the preferred collection on the basis thereof, and that the administering means charge a fee to a provider of the picture element for prioritizing the picture element within the storage location. A picture element designated as such which has been added to the storage location by or on behalf of a provider can, against payment, thus be given a higher ranking in one or more collections in the devices of optionally selected other users.

A selection of users can for instance take place here on the basis of personalized selection criteria, but optionally also in accordance with the geographical location of a user. The users in question then come across said picture element in decreasing order of priority in one or more collections of picture elements in their device. In an associated business model the system according to the invention is characterized here in that the administering means make charge a fee to a provider of the picture element for a use of a picture element from the storage location by a user. The actual use of the prioritized picture element is charged here to the provider. This model can then be implemented instead of or in addition to a fee charged for the prioritization itself.

The picture elements of the storage location can if desired also be made available against payment. A particular embodiment of the system according to the invention has for this purpose the feature that the administering means charge a fee to the user for a use of a picture element from the storage location.

The selection of a picture element from the storage location can on the other hand also be stimulated by a provider of a picture element so that it is given more public attention. With this in mind a further embodiment of the system according to the invention has the feature that the administering means remunerate the user for a use of a picture element from the storage location. This for instance involves stimulating the use of commercial brand logos or advertising posters. The remuneration can for instance take the form of a monetary payment to a (bank) account held by the user, but for instance also comprise a discount code or discount coupon which can be redeemed against specific products or services. Not only is the (name) awareness of the respective supplier/provider increased, but also the sale of their products or services.

In order to control the size of the preferred collection while picture elements are continuously being added thereto, a further particular embodiment of the system according to the invention has the feature that one or more picture elements with a lowest incidence of use in the preferred collection make way for one or more picture elements with a higher incidence of use.

In order to further personalize a picture element a further particular embodiment of the system according to the invention has the feature that at least one picture element in the preferred collection is modifiable and that the program code enables the user to change one or more aspects of the picture element, such as a colour of the picture element and/or a font and typeface of text incorporated therein.

A further particular embodiment of the system according to the invention here provides a device with a totally new and wholly innovative user interface with which such and other aspects can be designed and changed in particularly intuitive and simple manner by a user. Such a device is characterized according to the invention in that the program code is able and configured to generate a selection window at the picture message in which a number of successive options for an aspect of the picture element are displayed and presented graphically, wherein the picture element takes on an option of the aspect as soon as the picture element is placed in the selection window and at the position of the graphic display of the option, in particular by dragging the picture element over the graphic display of the option. The picture element can thus take on a number of successive forms by simply dragging or transferring the picture element in the selection window. Once a desired form is found, the picture element is dragged out the window and the picture element appears in the chosen form in the picture message. This provides for an exceptionally intuitive user experience.

The invention is suitable in principle for apparatuses and devices of diverse nature with which it is possible to communicate over a network, such as particularly also desktop computers and the like. In a particular embodiment the system according to the invention is however characterized in that the telecommunication device comprises a personal mobile phone device of the user and that the program code executes a program code which has been obtained from a storage location with program codes. This is understood to mean mobile devices such as smart phones, smart watches and tablet computers as well as all manner of future devices of similar or comparable nature that are yet to make an appearance.

### BRIEF DESCRIPTION OF THE DRAWINGS:

The invention will now be further elucidated on the basis of an exemplary embodiment and an accompanying drawings. In the drawings:

FIG. 1 shows a schematic setup of a system according to invention;

FIGS. 2A-B show an exemplary embodiment of a device and user interface for application in the system according to the invention at successive stages of use;

FIG. 3 shows an exemplary embodiment of a user interface of a device according to the invention in a first form of use; and

FIG. 4 shows the device and the user interface of FIG. 3 in a second form of use.

The figures are otherwise purely schematic and not drawn to scale. Some dimensions in particular may be exaggerated to greater or lesser extent for the sake of clarity. Corresponding parts are designated as far as possible in the figures with the same reference numeral.

### DETAILED DESCRIPTION OF THE INVENTION:

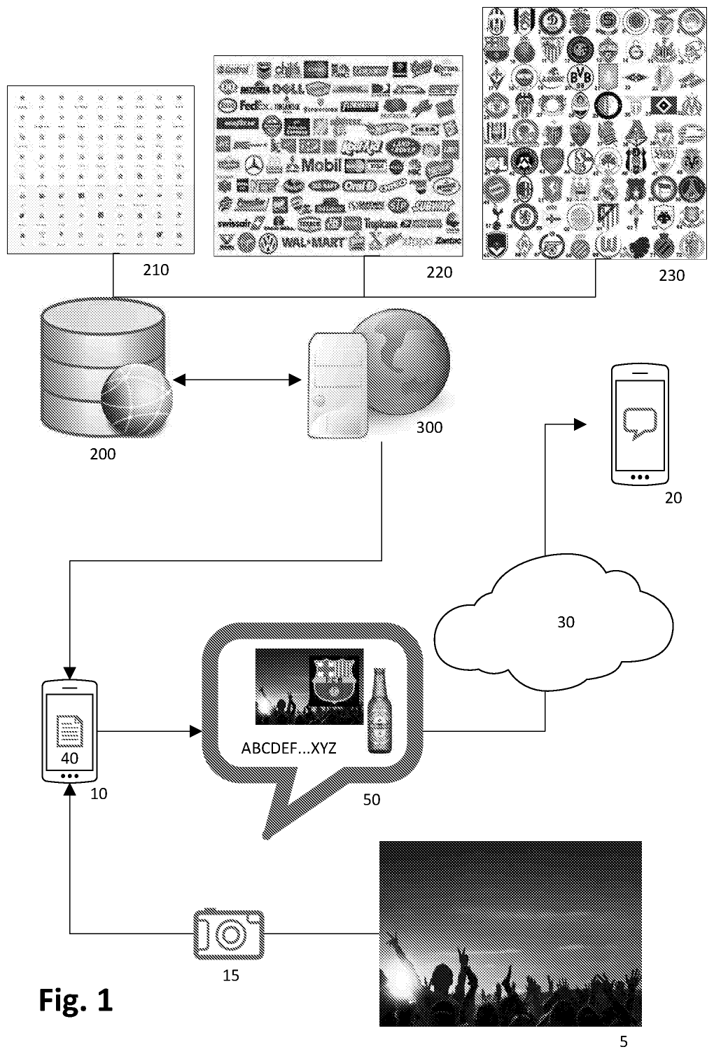

FIG. 1 shows a system with which personal messages can be exchanged between users. The users have for this purpose a telecommunication device 10,20 which enables the user to establish and maintain a telecommunication connection 30. Both telecommunication devices 10,20 comprise in this case a smart phone, although use can also be made instead of a smart watch, laptop, tablet or desktop computer to send or receive a message, and different forms of virtual and augmented reality applications will add a wide range of applications thereto in the future. The telecommunication connection 30 is only shown schematically in the figure and can take diverse forms in practice. It is particularly an optionally fixed connection in a public mobile or fixed telephony network or an IP computer network, such as the Internet in particular. The messaging is handled herein by one or more per se known message servers.

A suitable program code (software) 40 is operational on the sending device 10 for the purpose of composing, configuring and sending a message 50. This is particularly program code which has been obtained, optionally via the user, from an external source such as for instance the Internet, for instance in that the user, optionally against payment, has loaded an App provided for the purpose from a collection point for program codes (App store). In addition to being used to configure a message, this App provides a link to software which has optionally been loaded into and is operational in the device and which provides access to a social media channel from a diversity of channels such as the now immensely popular WhatsApp®, Instagram®, LinkedIn® or Facebook®.

The relevant client-software application (App) 40 enables a user to compose and configure a message 50 with his/her telecommunication device 10 and to then send it over a telecommunication connection 30 to another user, in particular another user of a shared social media channel. For this purpose the user selects an image 5 as basis for the message. This is for instance an image 5 already stored in or on his/her device 10 or an image 5 which he/she has been able, via device 10, to load therein. This is particularly a photographic recording 5 which has been made by the user with the camera 15 available in his/her device, for instance of and during an event in which he/she is taking part.

In the system according to the invention the telecommunication device 10 additionally provides selection means which enable a user to select one or more picture elements from a public storage location for picture elements 220,230 and add them to the message. In order to allow a user rapid and simple access to the pictures which are most popular, a number of picture elements are collected in the form of a personal preferred collection 210. Present in the preferred collection 210 are the picture elements which have been sent earlier by the user him/herself and pictures from messages of others having the greatest incidence therein. The preferred collection 210 can optionally also be configured on the basis of statistical data obtained from the Internet, for instance an incidence index of all messages which have been handled by a social media server or other message service, wherein the content of the preferred collection 210 can vary per social media channel. Pictures which the user him/herself adds to the storage location 210 . . . 230 are also stored in his/her personal preferred collection 210. The thus added pictures are then quickly and easily selectable by the user in any subsequent message 50. The preferred collection thus varies from user to user. Although the preferred collection 210, just as the other picture elements from the storage location, can be stored remotely from the device as shown in the figure and so do not take up any space in the memory of device 10, it is also possible to opt to arrange this collection of picture elements locally, i.e. in or on the device.

The picture elements which fall outside the preferred collection 210 but which are still provided are present in the second, usually considerably larger public part of the storage location 220,230. This remaining collection 220,230 is subdivided into sub-collections from which the user can draw freely or for payment. These sub-collections comprise for instance various brand logos of products or services, club logos of sports clubs, events and other organizations, in addition to for instance flags, coats of arms and other designations in image form of geographical territories such as countries, provinces and cities. Other commercial messages of graphic nature can also be included in the collection 210-230 of picture elements, such as for instance more generally applicable pictures (emoticons) which arouse an emotion or impart the overall message.

The further sub-collections 220,230 of picture elements which are thus provided with or without payment are presented in clear manner via an app interface 40 to the user via one or more menu structures and search options. It will be apparent that many other sub-collections can thus still be added to storage location 200 and made available. The program code 40 enables the user to make a connection with his/her device 10 to a web server 300 which provides access to a storage location 200 for a collection of picture elements.

Users can themselves particularly also upload picture elements to the public storage location 200 by means of the loaded software app 40. Pictures can be stored here privately in the preferred collection 210 for the exclusive use of the user him/herself or a group of users which has been authorized therefor, or be released to the public in one of the other sub-collections 220,230 for use by others. The storage location 200 is administered by an administration system which registers and keeps track of a download incidence per image and, if desired, adds to the preferred collection 210 the images with the highest incidence as calculated for all users in the network.

Special conditions or bonuses can also be linked to downloading of specific images. In the first case this would for instance involve a financial remuneration for the use of the respective image; in the latter case for instance commercial incentives such as discount offers. The picture elements thus selected by the user using the program code 40 are added to the message and combined by means of the software 40 with the primary image 5 to form a composite image and sent as such, optionally supplemented with text elements, as message 50.

It is noted here that the storage location 210,220,230 of picture elements can be not only static but also dynamic in the sense that the content or the presentation thereof to the user can be configured differently depending on location and time. On the basis of a known location of the user one or more picture elements or sub-collections of picture elements geared to this location can be provided with particular emphasis in the storage location. The location can be automatically identified in the system in that a location provision is activated in the device of the user. This is a specific routine in the device which identifies a physical location of the telecommunication connection in the network, or a positioning system, in particular a satellite-controlled positioning system such as NAVSTAR (GPS), GLONASS, BeiDou or the future European Galileo, which determines a geographical location of the device, and thereby of the user, and makes this available to the program code whereby the storage location is approached. A physical location of the device, and thereby of the user, can also be derived from a locally disposed iBeacon.

In all these and other cases the supply from the storage location can be adjusted at this location. At or within a predetermined radius from a festival terrain a logo of the festival or of one or more sponsors thereof can for instance thus be presented, and public buildings, institutions and theme parks can likewise provide a logo or other picture element which is then presented in the second collection as soon as the user is present at the location or in the vicinity thereof. These location-related picture elements are can optionally be provided in an individual sub-collection or via a specific button or operation of the second selection means.

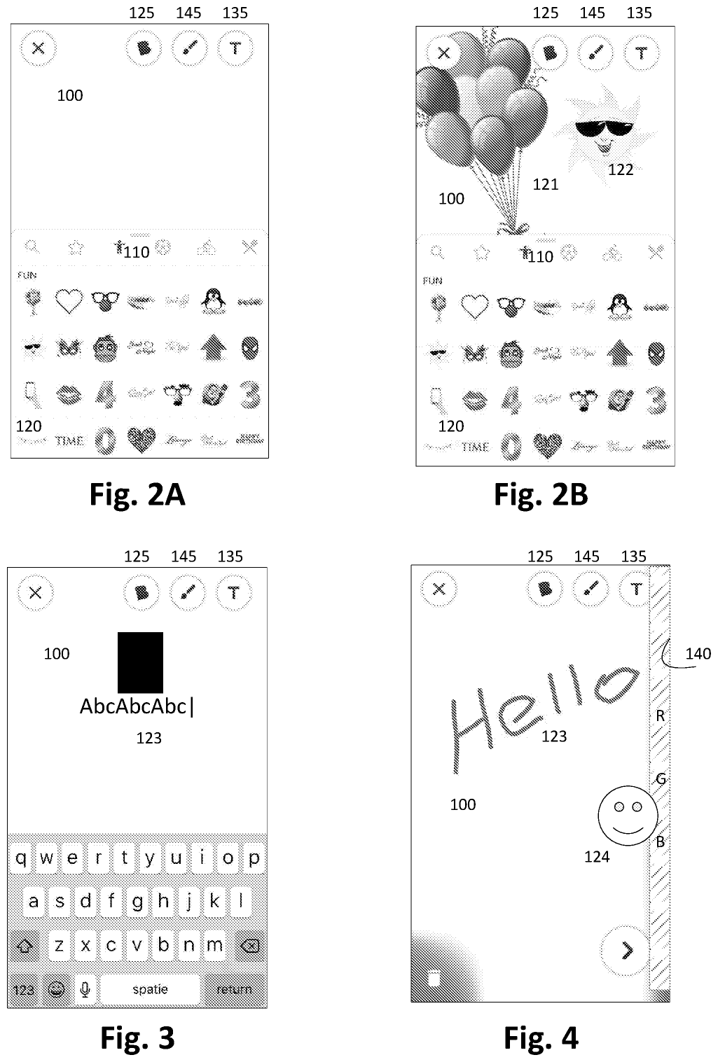

FIGS. 2A and 2B show an example of a device and an associated user interface which has been generated thereon by the program code and which makes it possible in exceptionally simple and transparent manner to configure a picture message as desired. The device here is a smart phone with a touchscreen, although use can also be made instead in similar manner of a tablet or laptop computer with a touchscreen. In the absence of a touchscreen the same functions can be performed in similar manner using a mouse.

The user interface substantially comprises two windows lying one above the other, viz. an image window 100 and a selection frame 110,120 below it. The selection window is brought up by touching a screen button 125. Picture elements which are made available by the device appear in the selection frame 120. These picture elements 120 are divided over a number of categories 110 in order to enhance the findability thereof and comprise, in addition to a standard collection, picture elements supplied by the user him/herself and/or obtained from the collection 210 . . . 230. In addition, the system is here able to add picture elements while bypassing the user, for instance on the basis of a geographical location of the user, his/her personal profile and/or because, with this in mind, another user has provided a picture element (for payment). In addition to a subdivision 110, the selection frame 120 also comprises a search function with which a picture element can be located quickly and easily.

In order to compose a picture message 50 to be sent, a picture element 121,122 is selected (clicked) in the selection frame so that it appears centrally in the image window 100, see FIG. 2B. This can alternatively be brought about by dragging the desired picture element from the selection frame to the screen. A different background can if desired be preselected by loading to image window 100 an existing photo or a photo created at the moment itself with the device. In that case the picture element 121,122 will appear on top of such a photo. The picture element 121,122 can now be moved (dragged) in the image window and optionally made smaller or larger in a manner such as provided by the operating system (OS) of the device. Further picture elements 121,122 can desired be added to the message in the same way.

A text can also be added to the message by touching the screen button 135,145 provided for the purpose, see FIG. 3. A user can thus enter text which is added by the system as graphic picture element to the picture similarly to a picture element 121,122 from the collection 120. This can be done in the handwriting of the user by touching the freehand button 145 provided for the purpose, but also in one of standard fonts provided for the purpose once the font key 135 has been clicked. In the latter case the user interface of the device provides a particularly intuitive way in which the format of such a text block can be changed if desired.

In the first place the standard font in which the text block 123 is shown can be changed to another of a series of standard fonts provided by the program code. In this example there are a number of fonts (twelve) in which the picture element 123 can be formatted. Moving successively through the different fonts of the series is carried out by swiping left or right in the image window above the text block. As soon as a different font is activated, the graphic text block 123 takes on the respective typeface/font. The alternative format thus appears in real-time in the text block 123. The image window is released at the desired format and the text block retains the chosen format.

In a likewise particularly intuitive manner a colour of picture elements opened for the purpose can also be changed, see FIG. 4. The colour of text and/or pictures entered by means of the freehand tool 145 and text blocks entered by means of the text tool 135 can always be changed. For this purpose the respective picture element is touched, whereby a colour window 140 appears in which successive colour definitions are represented graphically in a colour bar from red to ultramarine. Stored for all or at least a number of the picture elements 120 in the storage location is one bit of metadata which is designated as colour-changeable, this indicating whether or not the respective picture element is available for colour change. If this is the case, the picture element will then take on a different colour as soon as the picture element has been dragged into colour window 140 corresponding to the current position of bar 140. The picture element can thus be easily shown in a continuum from red to ultramarine by being dragged from top to bottom over bar 140. At a desired colour definition the picture element is released and it moves back to (the middle of) the screen in the chosen colour and retains the chosen colouring. A text block 123 or freehand drawing can also be thus executed in a desired colour. For a more extensive colour bar the program code will optionally suppress the selection frame 120 temporarily so that more space is available. The selection frame 120 is then temporarily not visible.

It will be apparent that such a user interface can be applied not only to select a colour but also a font. Numerous other aspects of a picture and/or text element are moreover adjustable by the user in similar and likewise intuitive manner. Such a user interface can also be applied advantageously in a device outside the context of the system according to the invention.

The finally configured and formatted message 50 is sent to a receiver in the network who can open and if desired reply to the message with his/her own personal telecommunication device 20 (smart phone). By making use of such composite images as communication the message 50 can remain relatively short, whereby not only the input time thereof but also the loading of the telecommunication connection is limited. Given the immense number of messages exchanged daily, this can result in an enormous time-saving.

Although the invention has been further elucidated above on the basis of only a single exemplary embodiment, it will be apparent that the invention is by no means limited thereto. On the contrary, many variations and embodiments are still possible within the scope of the invention for a person with ordinary skill in the art.

The invention is thus not limited to only brands and other company logos as picture elements, but numerous picture elements geared to social media can for instance be added thereto, and the invention rather provides a platform for the development of numerous new logos and other forms of picture element which, because of the invention, can then be made accessible in a practical manner, optionally for payment, to the user.

From a commercial perspective the system provides commercial users the option of registering and administering a picture element, such as for instance their own (brand) logo. The administering means subsequently provided periodic reporting in respect of for instance a number of times that the respective logo in the collection has been supplied, used and/or shared between users. A remuneration can be linked hereto, for instance from the moment that a specific threshold is exceeded in respect of the number of selections, use and/or sharing. Prior to this the system is available at no cost.

A supply is created as soon as the picture element is findable and available in the user interface of the device of a user, while a picture element is shared as soon as it has been forwarded via a social media channel. The remuneration can be calculated here per period of time or per supply, use and/or sharing of the respective picture element, to which a graduated scale and tariff structure can be linked. Supply, use and/or moment of sharing by a user of the system is preferably charged here to a prepaid balance of the commercial user (the company). Selections, use and/or moments of sharing can thus be easily accounted for and charged, wherein it is possible to purchase additional supply, use and/or sharing. Reporting can moreover comprise an analysis of the users of the respective picture element, wherein for instance the gender, age and/or an area of interest of the users will become apparent.

In addition to geographical placing of logos, it is also possible to provide hashtags (with or without a logo) at geographical level. This is particularly relevant in the case of events. In addition to providing a logo, an organizer can opt to also provide an on-site hashtag (#organizer). In the case a user is in the vicinity, in particular is a visitor, and uses his/her device to take a photo at the location, the preferred collection appears with geographical logos as well as geographical hashtags therein. Greater name awareness and branded business can hereby be realized for the organizer, such as for instance a restaurant or other hospitality establishment or an event organizer. Hashtags can be provided in the preferred collection as well as in other creative ways, such as for instance a moving bar at the top of the screen of the device.

All in all, the invention provides in the system with the preferred collection a personalized, directly accessible storage location for picture elements as if it were a second keyboard with which a picture element can be added to a message to be sent and/or processed quickly and easily.

1. A system for messaging over a telecommunication connection, comprising a personal telecommunication device with telecommunication means which are intended and configured to at least temporarily maintain a telecommunication connection, and with processor means which are able to execute a program code which enables a user to configure and send an electronic picture message over the telecommunication connection, which picture message comprises at least one first picture element,
wherein the program code provides access to a public storage location for picture elements located outside the telecommunication device,
wherein the program code provides selection means configured to select one or more further picture elements from the public storage location for picture elements and add them to a personalized preferred collection of picture elements optionally held by the telecommunication device and accessible thereby, and
wherein the program code enables the user to select a further picture element(s) from the preferred collection and combine it in the picture message with the at least one first picture element to form a composite image in the picture message.

2. The system as claimed in claim 1, wherein the program code is able and configured to send the picture message via a social media application of the telecommunication device, in particular a social media application from a group of social media applications available in the device.

3. The system as claimed in claim 1, wherein program code is able and configured to enable the user to add one or more picture elements to the storage location.

4. The system as claimed in claim 1, wherein the preferred collection is stored in or on the device.

5. The system as claimed in claim 1, wherein administering means are provided which register a use of a picture element from the storage location.

6. The system as claimed in claim 5, wherein the administering means charge a fee to the user for a use of a picture element from the storage location.

7. The system as claimed in claim 5, wherein the administering means are able and configured to assign a priority to a picture element in the storage location and to configure and present the preferred collection on the basis thereof, and wherein the administering means charge a fee to a provider of the picture element for prioritizing the picture element within the storage location.

8. The system as claimed in claim 7, wherein the administering means charge a fee to a provider of the picture element for a use of a picture element from the storage location by a user.

9. The system as claimed in claim 5, wherein the administering means remunerate the user for a use of a picture element from the storage location.

10. The system as claimed in claim 5, wherein the administering means are able and configured to determine an incidence of use of a picture element from the storage location and to configure and present the preferred collection on the basis thereof.

11. The system as claimed in claim 10, wherein the preferred collection comprises a set of picture elements with a highest incidence of use within exchanged picture messages of the user and/or other users of the system.

12. The system as claimed in claim 1, wherein at least one picture element in the preferred collection is modifiable and wherein the program code enables the user to change one or more aspects of the picture element, such as a colour of the picture element and/or a font and typeface of text incorporated therein.

13. The system as claimed in claim 12, wherein the program code is able and configured to generate a selection window at the picture message in which a number of successive options for an aspect of the picture element are displayed and presented graphically, and wherein the picture element takes on an option of the aspect as soon as the picture element is placed in the selection window and at the position of the graphic display of the option, in particular by dragging the picture element over the graphic display of the option.

14. The system as claimed in claim 1, wherein the telecommunication connection comprises an optionally permanent connection in a telecommunication network, in particular in a public telecommunication network.

15. The system as claimed in claim 1, wherein the telecommunication device comprises a personal mobile phone device of the user and wherein the program code executes a program code which has been obtained from a storage location with program codes.

16. The system as claimed in claim 1, wherein positioning means are provided which enable the system to determine a current geographical location of the telecommunication device, and wherein the storage location has a location-dependent content adapted to the position of the telecommunication device determined by the positioning means.

17. A telecommunication device as applied in the system as claimed in claim 1.

18. The device as claimed in claim 17, comprising a user interface which is able and configured to generate a selection window in which a number of successive options for an aspect of a picture element are displayed and presented graphically, wherein the picture element takes on an option of the aspect as soon as the picture element appears in the selection window and at the position of the graphic display of the option, in particular in that the picture element is dragged over the graphic display of the option.
